(19) United States
(12) Patent Application Publication
(10) Pub. No.: US 2007/0238082 A1
(43) Pub. Date: Oct. 11, 2007

(54) E-CARD METHOD AND SYSTEM

(76) Inventor: Elizabeth Ingrassia, Garden City, NY (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/279,342

(22) Filed: Apr. 11, 2006

(51) Int. Cl. G09B 5/00

(52) U.S. Cl. 434/307 A

(57) ABSTRACT

A method and computer program product for generating a karaoke e-card comprising selecting an e-card, and defining at least a portion of a music track to be included within the e-card. At least a portion of a vocal track to be included within the e-card is recorded, the music track and the vocal track are synchronized.

### TECHNICAL FIELD

This disclosure relates to electronic greeting cards and, more particularly, to karaoke-based electronic greeting cards.

### BACKGROUND

Electronic greeting cards are available from numerous internet-based sources. Typically, a user logs onto a website and designs a greeting card that is sent electronically to the user. During the design process, the user may be allowed to select a card theme (e.g., birthday, anniversary, get well, etc.) and may be allowed to select from one or more predesigned greeting cards. Additionally, the user may be allowed to add a personalized greeting, such as a text-based or voice-based message.

### SUMMARY OF THE DISCLOSURE

In one implementation, a method of generating a karaoke e-card includes selecting an e-card and defining at least a portion of a music track to be included within the e-card. At least a portion of a vocal track to be included within the e-card is recorded and the music track and the vocal track are synchronized.

One or more of the following features may also be included. The e-card may be transmitted to a recipient. The e-card may be stored at a defined location, and an address indicative of the defined location may be transmitted to a recipient. Selecting an e-card may include selecting an e-card template from a plurality of predefined templates, and modifying the e-card template to define the e-card.

Modifying the e-card template may include one or more of: adding one or more new text characters to the e-card template; modifying one or more existing text characters included within the e-card template; adding one or more new graphic images to the e-card template; modifying one or more existing graphic images within the e-card template adding a video segment; editing a video segment; adding a photographic image; and editing a photographic image. A user may be provided with lyrics concerning the portion of the vocal track to be included within the e-card. Providing a user with lyrics may include providing the user with one or more timing indicators that are synchronized with the music track. The music track may be rendered during the recording of the at least a portion of the vocal track. Synchronizing the music track and the vocal track may include combining the music track and the vocal track to generate a hybrid track. The hybrid track may be incorporated into the e-card. The hybrid track may be encoded using MPEG1 encoding, MPEG 2 encoding, MPEG 4 encoding, and/or Advanced Audio Coding.

In another implementation, a computer program product resides on a computer readable medium and has a plurality of instructions stored on it. When executed by a processor, the instructions cause the processor to perform operations comprising selecting an e-card and defining at least a portion of a music track to be included within the e-card. At least a portion of a vocal track to be included within the e-card is recorded and the music track and the vocal track are synchronized.

One or more of the following features may also be included. The e-card may be transmitted to a recipient. The e-card may be stored at a defined location, and an address indicative of the defined location may be transmitted to a recipient. Selecting an e-card may include selecting an e-card template from a plurality of predefined templates, and modifying the e-card template to define the e-card.

Modifying the e-card template may include one or more of: adding one or more new text characters to the e-card template; modifying one or more existing text characters included within the e-card template; adding one or more new graphic images to the e-card template; modifying one or more existing graphic images within the e-card template adding a video segment; editing a video segment; adding a photographic image; and editing a photographic image. A user may be provided with lyrics concerning the portion of the vocal track to be included within the e-card. Providing a user with lyrics may include providing the user with one or more timing indicators that are synchronized with the music track. The music track may be rendered during the recording of the at least a portion of the vocal track. Synchronizing the music track and the vocal track may include combining the music track and the vocal track to generate a hybrid track. The hybrid track may be incorporated into the e-card. The hybrid track may be encoded using MPEG1 encoding, MPEG 2 encoding, MPEG 4 encoding, and/or Advanced Audio Coding.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an e-card generation system coupled to a distributed computing network;

FIG. 2 is a diagrammatic view of a display screen rendered by the e-card generation system of FIG. 1;

FIG. 3 is a flow chart of a process executed by the e-card generation system of FIG. 1;

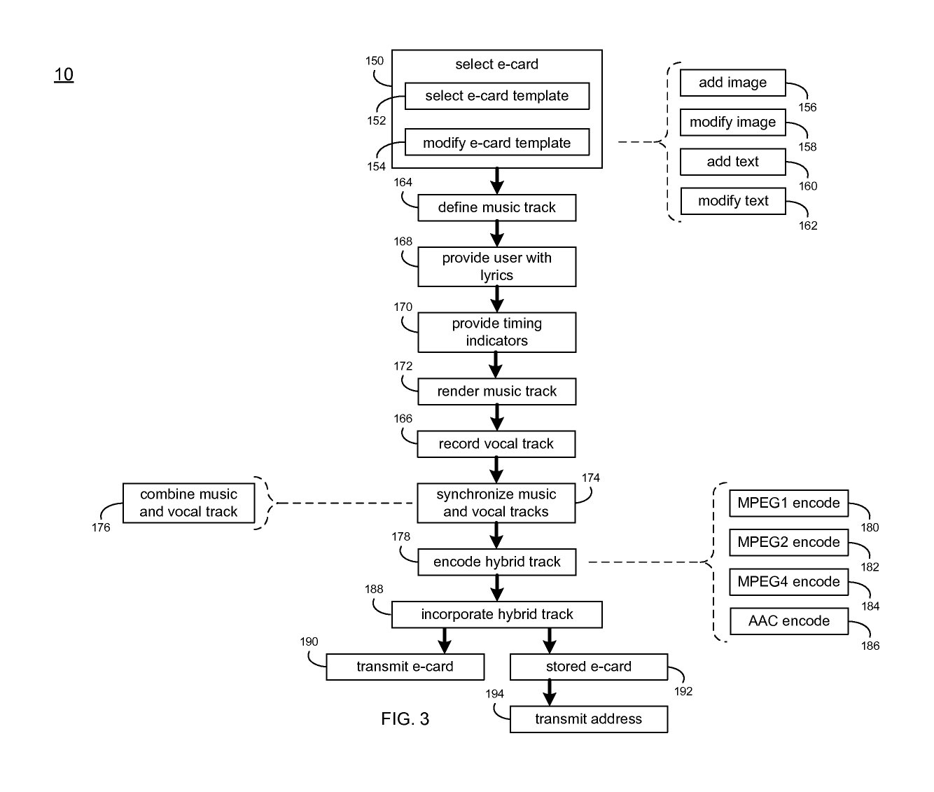

FIG. 4 is a diagrammatic view of a display screen rendered by the e-card generation system of FIG. 1;

FIG. 5 is a diagrammatic view of a display screen rendered by the e-card generation system of FIG. 1; and

FIG. 6 is a diagrammatic view of a display screen rendered by the e-card generation system of FIG. 1.

### DETAILED DESCRIPTION OF THE PREFERRED EMBODIMENTS

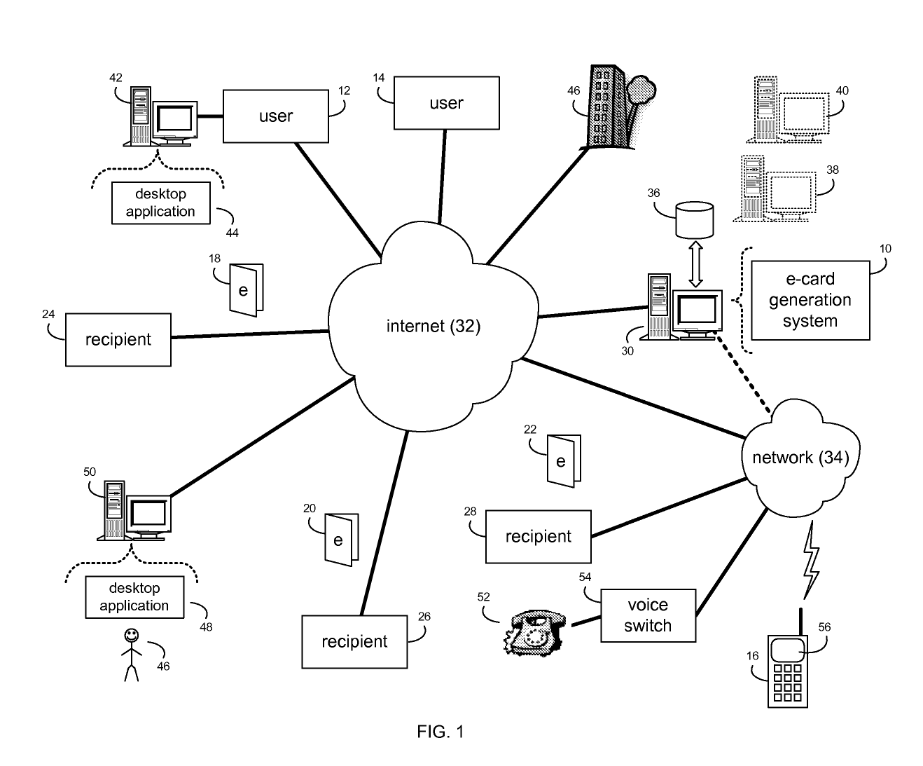

Referring to FIG. 1, there is shown a e-card generation system 10 that allows users (e.g., users 12, 14, 16) to design and transmit e-cards 18, 20, 22 to various recipients 24, 26, 28.

Electronic greeting card system 10 typically resides on and is executed by a computer 30 that is connected to network 32 (e.g., the internet). Computer 30 may be a web server running a network operating system, such as Microsoft Window 2000 Server™, Novell Netware™, or Redhat Linux™. Typically, computer 30 also executes a web server application, such as Microsoft IIS™, Novell Webserver™, or Apache Webserver™, that allows for HTTP (i.e., HyperText Transfer Protocol) access to computer 30 via network 32. Network 32 may be connected to one or more secondary networks (e.g., network 34), such as: a local area network; a wide area network; or an intranet, for example.

The instruction sets and subroutines of electronic greeting card system 10, which are typically stored on a storage device 36 coupled to computer 30, are executed by one or more processors (not shown) and one or more memory architectures (not shown) incorporated into computer 30. Storage device 36 may be, for example, a hard disk drive, a tape drive, an optical drive, a RAID array, a random access memory (RAM), or a read-only memory (ROM). Additionally/alternatively, electronic greeting card system 10 may be executed on one or more additional computers 38, 40, thus allowing for increased bandwidth and/or more efficient data processing.

Users 12, 14, 16 and recipients 24, 26, 28 may access electronic greeting card system 10 directly through network 32 or through a secondary network (e.g., network 34). Further, computers 30, 38, 40 (i.e., the computer(s) that execute electronic greeting card system 10) may be connected to network 32 through a secondary network (e.g., network 34).

Users 12, 14, 16 and recipients 24, 26, 28 may access electronic greeting card system 10 through a computer (e.g., computer 42) that is connected to network 32 (or network 34) that executes a desktop application 44 (e.g., Microsoft Internet Explorer™, Netscape Navigator™, or a specialized interface).

An administrator 46 may access and administer electronic greeting card system 10 through a desktop application 48 (e.g., Microsoft Internet Explorer™, Netscape Navigator™, or a specialized interface) running on an administrative computer 50 that is also connected to network 32 (or network 34).

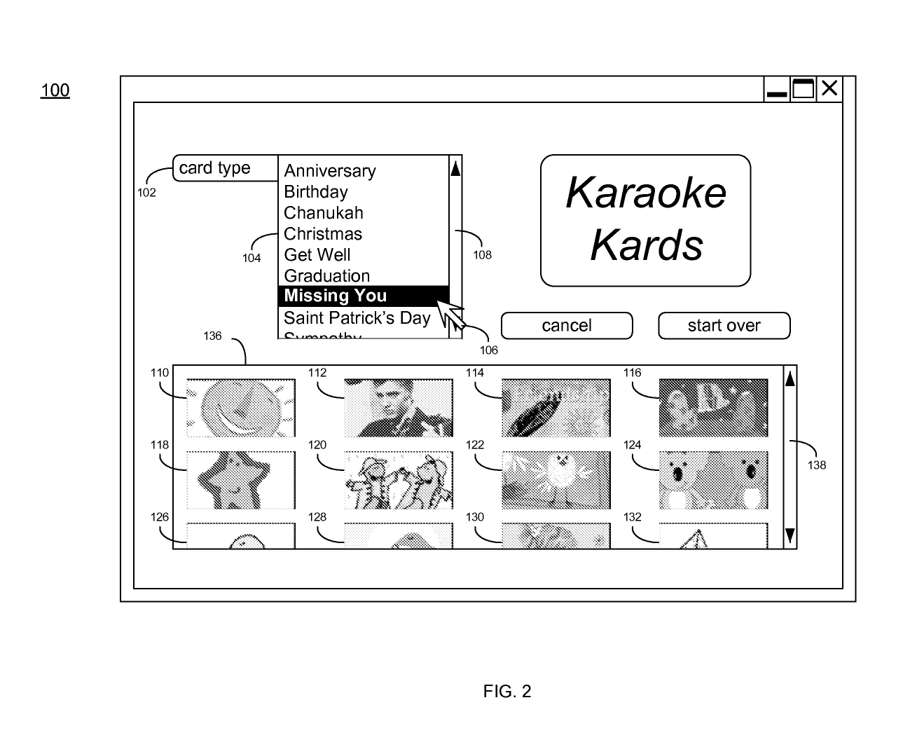

Referring also to FIGS. 2 & 3, when accessing e-card generation system 10 via e.g., computer 42, user 12 may be presented with a display screen (e.g., web page 100 rendered by e-card generation system 10) that allows a user (e.g. user 12) to select 150 the type of e-card to be transmitted to the recipient (e.g., recipient 24). For example, user 12 may select 150 the card type 102 via drop down menu 104. Drop down menu 104 may be activated via a screen pointer 106 that is controllable by a pointing device (e.g., a computer mouse, track ball, touch pad, and/or guide point, not shown). In this particular example, drop down menu 104 is shown to include nine “card types”, namely: “Anniversary”; “Birthday”; “Chanukah”; “Christmas”; “Get Well”; “Graduation”; “Missing You”; “Saint Patrick's Day”; and “Sympathy” (partially obscured). While drop down menu 104 is shown to include nine “card types”, this is for illustrative purposes only and the number of “card types” may be increased/decreased depending on need. If the number of “card types” exceeds the maximum number simultaneously displayable within menu 104, a scroll bar 108 may be rendered (by e-card generation system 10) that allows the user to scroll upward or downward to view the “card types” that are obscured or partially obscured (e.g., the “Sympathy” entry and any entries that are below “Sympathy”).

Upon user 12 selecting 150 a “card type”, one or more e-card templates may be rendered (by e-card generation system 10) for review and selection by user 12. For example, if user 12 selects 150 a card type of “Missing You”, web page 100 may be rendered to include a plurality of “Missing You” e-card templates, each of which may be selectable by user 12 via screen pointer 106. In this particular example, webpage 100 is shown to include twelve e-card templates, namely templates 110, 112, 114, 116, 118, 120, 122, 124, 126, 128, 130, 132, of which templates 126, 128, 130, 132 are partially obscured. If the number of e-card templates exceeds the maximum number simultaneously displayable within template window 136, a scroll bar 138 may be rendered that allows the user to scroll upward or downward to view the e-card templates that are obscured or partially obscured (e.g., e-card templates 126, 128, 130, 132 and any e-card templates that are below e-card templates 126, 128, 130, 132).

User 12 may select 152 (via screen pointer 106) one of the e-card templates, each of which is representative of a particular e-card. Assume for this example that user 12 selects 152 e-card template 112 (i.e., the “Elvis Presley” e-card template).

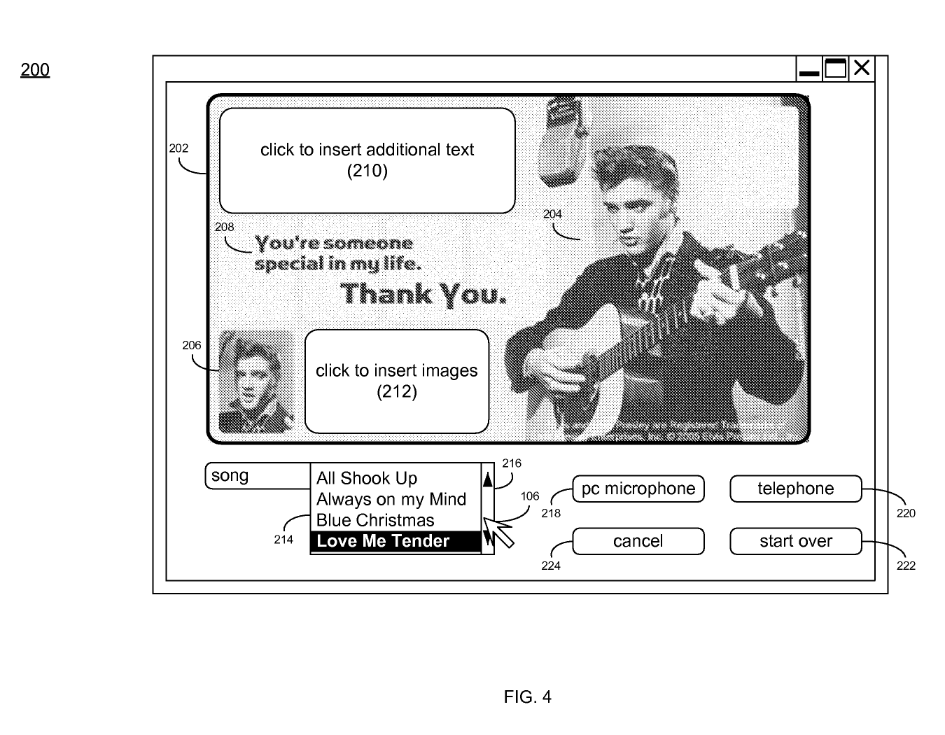

Referring also to FIG. 4, upon user 12 selecting 150 a “card type”, a display screen (e.g., web page 200) may be rendered by e-card generation system 10 that provides user 12 with a detailed view of the selected e-card (i.e., the e-card associated with e-card template 112). In this particular example, e-card 202 is shown to include a main image 204 (e.g., an image of Elvis Presley), one or more sub-images 206, pre-inserted text 208, a placeholder for insertable text 210, and a placeholder for insertable images 212.

E-card generation system 10 may allow user 12 to modify 154 e-card 202 to create a personalized e-card. For example, e-card generation system 10 may allow user 12 to add 156 a graphic/photographic image to e-card 202. To add a graphic/photographic image, user 12 may select (via screen pointer 106) the image insertion placeholder 212. E-card generation system 10 may allow user 12 to upload one or more graphic/photographic images for inclusion within e-card 202. Further, e-card generation system 10 may include a graphic/photographic image editing applet to allow for the addition of graphic/photographic images to e-card 200. Alternatively, a stand-alone graphic/photographic image editing program (e.g., Adobe Photoshop™) may be used to add a graphic/photographic image within e.g., image placeholder 212. This stand-alone graphic/photographic image editing program may be automatically launched upon user 12 selecting image placeholder 212. Once inserted, the newly-added graphic/photographic image may be repositionable within e-card 202 via screen pointer 106.

Additionally, e-card generation system 10 may allow user 12 to modify 158 an existing graphic/photographic image within e-card 202. To modify a graphic/photographic image, user 12 may select (via screen pointer 106) the graphic/photographic image to be modified (e.g., graphic/photographic image 204 and/or graphic/photographic image 206). E-card generation system 10 may include a graphic/photographic image editing applet to allow for the modification of the graphic/photographic image. Alternatively, a stand-alone graphic/photographic image editing program (e.g., Adobe Photoshop™) may be used to modify e.g., graphic/photographic image 204 and/or graphic/photographic image 206. This stand-alone graphic/photographic image editing program may be automatically launched upon user 12 selecting the graphic/photographic image to be modified. Once modified, the newly-modified graphic/photographic image may be repositionable within e-card 202 via screen pointer 106.

Further, e-card generation system 10 may allow user 12 to add 160 one or more text characters (i.e., text) to e-card 202. To add text to e-card 202, user 12 may select (via screen pointer 106) the text insertion placeholder 210. E-card generation system 10 may include a text-editing applet to allow for the addition of the text. Alternatively, a stand-alone text editing program (e.g., Microsoft Word™) may be used to add text within e.g., text placeholder 210. This stand-alone text editing program may be automatically launched upon user 12 selecting text placeholder 210. Once inserted, the newly-added text may be repositionable within e-card 202 via screen pointer 106.

Additionally, e-card generation system 10 may allow user 12 to modify 162 text included within e-card 202. To modify text, user 12 may select (via screen pointer 106) the text to be modified (e.g., pre-inserted text 208). E-card generation system 10 may include a text-editing applet to allow for the modification of the text. Alternatively, a stand-alone text editing program (e.g., Microsoft Word™) may be used to modify e.g., pre-inserted text 208. This stand-alone text editing program may be automatically launched upon user 12 selecting the text to be modified. Once modified, the newly-modified text may be repositionable within e-card 202 via screen pointer 106.

E-card generation system 10 may be capable of performing additional functionality, such as: allowing user 12 to change the background color of the e-card, and allowing user 12 to add various background patterns and/or borders to the e-card, for example.

E-card generation system 10 may allow user 12 to define 164 at least a portion of a music track included within e-card 202. The music track included within the e-card may be a karaoke music track (e.g., a recording of a music track in which the vocals have been removed). For example, as e-card 202 is an “Elvis” themed e-card, user 12 may be allowed to define 164 one of several Elvis Presley songs as the karaoke music track. Alternative, e-card generation system 10 may allow user 12 to define 164 a music track regardless of the track's performer.

In this particular example, webpage 200 is shown to include four selectable music tracks, namely: “All Shook Up”, “Always on my Mind”; “Blue Christmas”; and “Love Me Tender”. If the number of selectable music tracks exceeds the maximum number simultaneously displayable within drop down menu 214, a scroll bar 216 may be rendered that allows the user to scroll upward or downward to view any selectable music tracks that are obscured or partially obscured (e.g., any selectable music track(s) that are below “Love me Tender”).

E-card generation system 10 may allow user 12 to record 166 at least a portion of a vocal track that corresponds with the selected karaoke music track. Once the karaoke music track is defined 164, user 12 may define the manner in which the vocal track is to be recorded 166. For example, the vocal track may be recorded 166 via a microphone (not shown) attached to e.g., computer 42. Alternatively, the vocal track may be recorded 166 via telephone 52/cellular telephone 16. Telephone 52 may be coupled to network 32 and/or network 34 via voice switch 54. Cellular telephone 16 may be coupled to network 32 and/or network 34 via a cellular network (not shown). If the user chooses to record 166 the vocal track via e.g., telephone 52/cellular telephone 16, user 12 may be provided with a telephone number and access code that allows user 12 to access computer 30 via e.g., voice switch 52.

If user 12 wishes to record the vocal track via a microphone attached to e.g., computer 42, user 12 may select the “pc microphone” button 218. Alternatively, if user 12 wishes to record the vocal track via telephone 52, user 12 may select the “telephone” button 220. Alternatively, if user 12 wishes to restart the e-card creation process, user 12 may select the “start over” button 222. Further, if user 12 wishes to cancel the e-card creation process, user 12 may select the “cancel” button 224.

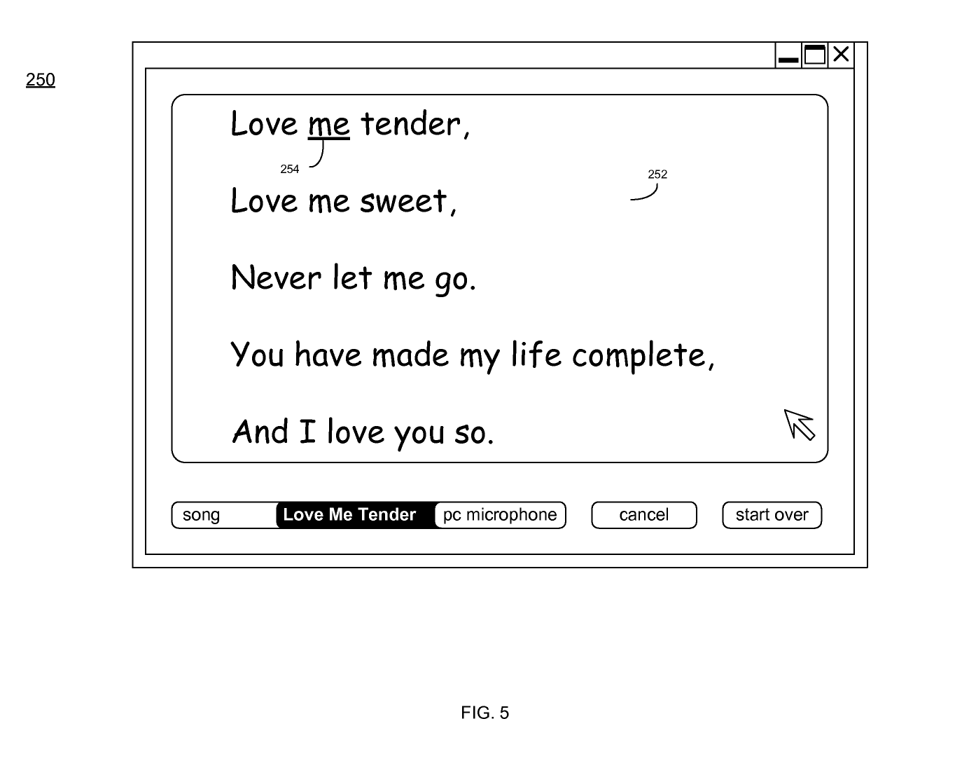

Referring also to FIG. 5, when choosing to record 166 a vocal track (via a pc microphone or telephone 52), e-card generation system 10 may render a display screen (e.g., web page 250) that provides 168 lyrics 252 to the user for the selected karaoke music track. For example, assuming that user 12 selects karaoke music track “Love Me Tender”, web page 250 may include the lyrics 252 of “Love Me Tender”. Typically, the quantity of lyrics 252 provided 168 to the user will be proportional to the portion of the karaoke music track included within the e-card. For example, if the e-card is to include just the first thirty seconds of “Love Me Tender”, only the lyrics 252 to be sung within the first thirty seconds of “Love me Tender” may be provided 168 to the user.

In addition to providing 168 the lyrics 252 to the user, user 12 may be provided 170 with one or more timing indicators that allow user 12 to synchronize their singing of the lyrics 252 with the selected karaoke music track. Typically, once a karaoke music track is selected by the user and web page 250 is rendered, e-card generation system 10 will render (i.e., play) 172 the selected karaoke music track. The manner in which this track is rendered 172 for the user may vary depending on the manner in which the user is recording 166 the vocal track. For example, if the user is recording 166 the vocal track using a pc microphone, the karaoke music track may be rendered 172 through one or more speakers (not shown) attached to computer 42. Alternatively, if the user is recording the vocal track using telephone 52, the karaoke music track may be rendered 172 through the ear piece of telephone 52.

Continuing with the above-stated example, as user 12 selected “Love Me Tender” as the karaoke music track, when e-card generation system 10 renders webpage 250, the portion of the lyrics 252 that corresponds with the portion of the karaoke music track to be included within e-card 202 may be provided 168 to user 12. Additionally, the karaoke music track may be rendered 172 for the user, thus allowing for the recordation 166 of the vocal track as the user sings along with the karaoke music track. In order to synchronize the user's recordation 166 of the vocal track with the rendering 172 of the karaoke music track, timing indicators may be provided 170 to user 12. In this example, the timing indicators provided within webpage 250 are an underline 254 that moves from word to word as the particular word within lyrics 252 is to be sung. While the timing indicator in this example is shown to be an underline, this is for illustrative purposes only and is not intended to be a limitation of this disclosure, as other configurations are possible. For example, a “bouncing ball” may move from word to word as the particular word within lyrics 252 are sung. Alternatively, the word to be sung may he highlighted or rendered in a different color.

While the karaoke music track is described above as being absent of (i.e., without) vocals, other configurations are possible and are considered to be within the scope of this disclosure. For example, e-card generation system 10 may allow the user to listen to a karaoke music track that includes vocals so that the user may e.g., better understand the inflection and timing of the vocals.

Once the vocal track is recorded 166, e-card generation system 10 may synchronize (i.e., align) 174 the vocal track and the karaoke music track. Synchronizing 174 the vocal track and the karaoke music track may occur in various ways. For example, when recording the vocal track, the recording of the vocal track may be initiated at the same time as the rendering of the karaoke music track. Accordingly, by aligning the starting point of the vocal track and the karaoke music track, the vocal track and karaoke music track may be synchronized 174. Alternatively, once the vocal track is recorded, the file associated with the vocal track may be analyzed to determine the starting point of the vocals within the vocal track. By aligning this starting point of the vocals within the vocal track with the point within the karaoke music track at which the vocals should start, the vocal track and the karaoke music track may be synchronized 174. The vocal track and/or the karaoke music track may be encoded using any known encoding algorithm, such as MPEG1, MPEG2, MPEG 4, and/or Advanced Audio Coding (i.e., AAC). Additionally/alternatively, the karaoke music track may be a MIDI (i.e. musical instrument device interface) track.

Once the vocal track and the karaoke music track are synchronized 174, the vocal track and the karaoke music track may be combined 176 to form a hybrid track, which may be encoded 178 into a widely used audio format. Accordingly, this hybrid track may be: encoded 180 using MPEG1 encoding; encoded 182 using MPEG 2 encoding; encoded 184 using MPEG 4 encoding; and/or encoded 186 using Advanced Audio Coding. Once generated, the hybrid track may be incorporated 188 into e-card 202

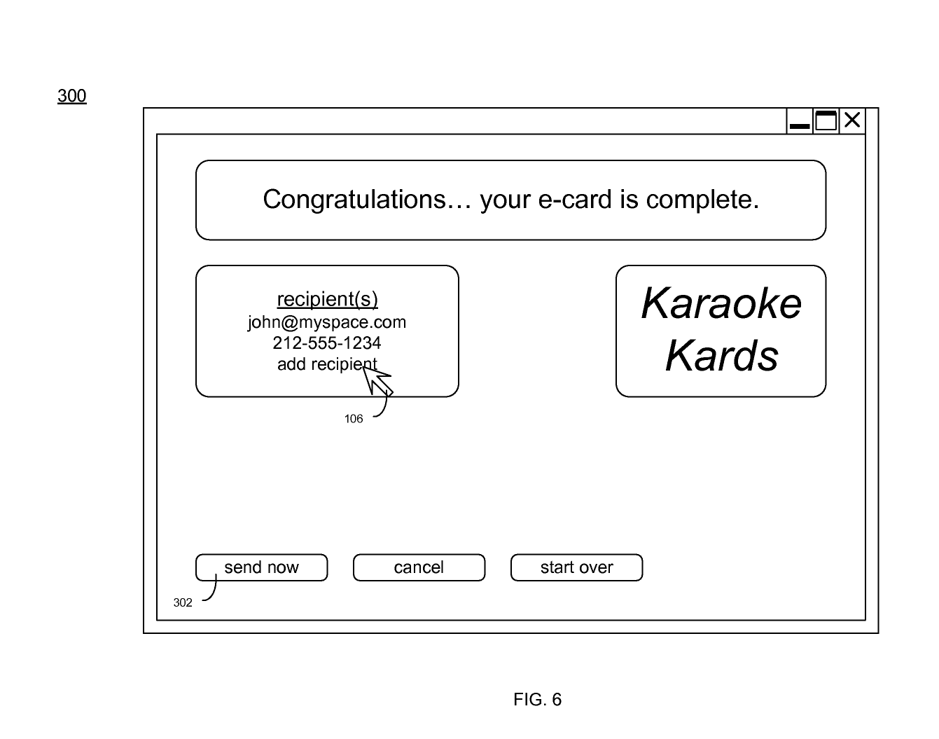

Referring also to FIG. 6, e-card generation system 10 may render a display screen (e.g., web page 300) that allows the user (e.g., user 12) to define one or more recipients for the e-card. When defining recipients, user 12 may select the “add recipient” place holder using screen pointer 106, which may result in the generation of a text box (not shown), into which user 12 may enter e.g., the email address of the intended recipient (e.g., recipient 24), a telephone number (e.g., when the intended recipient is a cellular telephone number), an IP address (e.g., when the intended recipient is an IP addressable computing device), and/or an instant messaging identifier (e.g., when the intended recipient is a user of an instant messaging program).

When user 12 has finished identifying recipients concerning e-card 202, user 12 may select the “send now” button (using screen pointer 106). By selecting the “send now”, an email may be transmitted 190 to recipient 24 that includes the e-card as e.g., an executable attachment or e.g., a Macromedia flash™ animation. Alternatively, e-card 202 may be locally stored 192 (e.g., on computer 30) and an address indicative of the location of the locally stored e-card may be transmitted 194 to recipient 24. An example of such an address is a URL (i.e., uniform resource locator) that locates e-card 202 within e.g., computer 30.

While users 12, 14 are described above as using a computer (e.g., computer 42) to create e-cards, other configurations are possible and are considered to be within the scope of this disclosure. For example, a user may access e-card generation system 10 via e.g., cellular telephone 16, a personal digital assistant (not shown), a laptop/notebook computer (not shown), or a cable television box (not shown), using various protocols (e.g., TCP/IP) and/or data services/systems (e.g., short message service and multimedia messaging service). Accordingly, web pages 100, 200, 250, 300 may be configured to be displayable on e.g., a display screen 56 of cellular telephone 16, a display screen of a personal digital assistant (not shown), a display screen of a laptop/notebook computer (not shown), or a television couple to a cable television box (not shown),

While system 10 is described above as allowing user 12 to add/modify text and add/modify graphic/photographic images, other configurations are possible and are considered to be within the scope of this disclosure. For example, system 10 may be configured to allow user 12 to add a video segment to e.g., e-card 202 and/or edit a video segment within e-card 202. Accordingly, when the vocal track is recorded by user 12, the vocal track may include a video segment so that the recipient of the e-card can watch the user sing the vocal track. The video segment added to e-card 202 may be uploaded using e.g., computer 42 and/or cellular telephone 16. Alternatively, video segment may be edited using e.g., computer 42 and/or cellular telephone 16.

While system 10 is described above as including one or more server-side applications (e.g., e-card generation system 10) that interface with one or more client-side applications (e.g., desktop application 44), other configurations are possible. For example, e-card generation system 10 may be resident upon and executed on a client-side device, such as computer 42, cellular telephone 16, a personal digital assistant (not shown), a laptop/notebook computer (not shown), or a cable television box (not shown), for example.

While e-card 202 is illustrated above as being a single-page e-card, other configurations are possible and are considered to be within the scope of this disclosure. For example, e-card 202 may be a multi-page e-card (not shown) that uses e.g., Macromedia Flash™ animation to turn the pages as the e-card is played.

A number of implementations have been described. Nevertheless, it will be understood that various modifications may be made. Accordingly, other implementations are within the scope of the following claims.

What is claimed is:

1. A method of generating a karaoke e-card comprising:
selecting an e-card;
defining at least a portion of a music track to be included within the e-card;
recording at least a portion of a vocal track to be included within the e-card; and
synchronizing the music track and the vocal track.

2. The method of claim 1 further comprising:
transmitting the e-card to a recipient.

3. The method of claim 1 further comprising:
storing the e-card at a defined location; and
transmitting an address indicative of the defined location to a recipient.

4. The method of claim 1 wherein selecting an e-card includes:
selecting an e-card template from a plurality of predefined templates; and
modifying the e-card template to define the e-card.

5. The method of claim 4 wherein modifying the e-card template includes one or more of:
adding one or more new text characters to the e-card template;
modifying one or more existing text characters included within the e-card template;
adding one or more new graphic images to the e-card template;
modifying one or more existing graphic images within the e-card template
adding a video segment;
editing a video segment;
adding a photographic image; and
editing a photographic image.

6. The method of claim 1 further comprising:
providing a user with lyrics concerning the portion of the vocal track to be included within the e-card.

7. The method of claim 6 wherein providing a user with lyrics includes:
providing the user with one or more timing indicators that are synchronized with the music track.

8. The method of claim 1 further comprising:
rendering the music track during the recording of the at least a portion of the vocal track.

9. The method of claim 1 wherein synchronizing the music track and the vocal track includes combining the music track and the vocal track to generate a hybrid track, the method further comprising:
incorporating the hybrid track into the e-card.

10. The method of claim 9 further comprising one or more of:
encoding the hybrid track using MPEG1 encoding;
encoding the hybrid track using MPEG 2 encoding;
encoding the hybrid track using MPEG 4 encoding; and
encoding the hybrid track using Advanced Audio Coding.

11. A computer program product residing on a computer readable medium having a plurality of instructions stored thereon which, when executed by a processor, cause the processor to perform operations comprising:
selecting an e-card;
defining at least a portion of a music track to be included within the e-card;
recording at least a portion of a vocal track to be included within the e-card; and
synchronizing the music track and the vocal track.

12. The computer program product of claim 11 further comprising instructions for performing operations comprising:
transmitting the e-card to a recipient.

13. The computer program product of claim 11 further comprising instructions for performing operations comprising:
storing the e-card at a defined location; and
transmitting an address indicative of the defined location to a recipient.

14. The computer program product of claim 11 wherein the instructions for selecting an e-card includes instructions for performing operations comprising:
selecting an e-card template from a plurality of predefined templates; and
modifying the e-card template to define the e-card.

15. The computer program product of claim 14 wherein the instructions for modifying the e-card template includes instructions for performing operations comprising one or more of the following:
adding one or more new text characters to the e-card template;
modifying one or more existing text characters included within the e-card template;
adding one or more new graphic images to the e-card template;
modifying one or more existing graphic images within the e-card template adding a video segment;
editing a video segment;
adding a photographic image; and
editing a photographic image.

16. The computer program product of claim 11 further comprising instructions for performing operations comprising:
providing a user with lyrics concerning the portion of the vocal track to be included within the e-card.

17. The computer program product of claim 16 wherein the instructions for providing a user with lyrics includes instructions for performing operations comprising:
providing the user with one or more timing indicators that are synchronized with the music track.

18. The computer program product of claim 11 further comprising instructions for performing operations comprising:
rendering the music track during the recording of the at least a portion of the vocal track.

19. The computer program product of claim 11 wherein the instructions for synchronizing the music track and the vocal track includes instructions for performing operations comprising combining the music track and the vocal track to generate a hybrid track, the computer program product further comprising instructions for performing operations comprising:
incorporating the hybrid track into the e-card.

20. The computer program product of claim 19 further comprising instructions for performing operations comprising one or more of the following:
encoding the hybrid track using MPEG1 encoding;
encoding the hybrid track using MPEG 2 encoding;
encoding the hybrid track using MPEG 4 encoding; and
encoding the hybrid track using Advanced Audio Coding.
